(19) United States
(12) Patent Application Publication
(10) Pub. No.: US 2026/0011239 A1
(43) Pub. Date: Jan. 8, 2026

(54) Automation System

(71) Applicant: Machine2Machine Solutions AB, Jönköping (SE)

(72) Inventor: Peter Hasselqvist, Jönköping (SE)

(21) Appl. No.: 19/112,172

(22) PCT Filed: Sep. 20, 2023
(86) PCT No.: PCT/EP2023/075975

§ 371 Date: Mar. 14, 2025

(30) Foreign Application Priority Data
Sep. 23, 2022 (SE) 2251103-4

(51) Int. Cl. G08C 17/00; G08C 23/04

(52) U.S. Cl. CPC G08C 17/00; G08C 23/04

(57) ABSTRACT

The present disclosure relates to systems and methods for distribution of signals. More specifically an adapter for wireless distribution of sensor and/or control signals to an external network is disclosed. The adapter is arranged to be mounted in a transmission path of a sensor device and/or a control system and is configured to obtain at least one first sensor signal from the sensor device and/or at least one first control signal from the control system. Further, the adapter is configured to convert each of the obtained at least one first signals to a corresponding at least one second signal such that each of the obtained at least one first signal is galvanically isolated from its corresponding second signal. The adapter is further configured to transmit, each of the converted corresponding second signals to the external network wirelessly via at least one wireless communication access point located remotely from the adapter.

### TECHNICAL FIELD

The present disclosure relates to distribution of signals generated by one or more entities such as sensor devices or control devices to an external network. More specifically, the aspects and embodiments of the present disclosure relate to automation systems and methods for distribution of signals generated by one or more sensor devices by means of one or more adapters to an external network in an interconnected network configuration of the automation system.

### BACKGROUND

One of the major areas of development in the automation and digitization of industrial processes touching upon internet of things are solutions which provide an all-connected network of components and entities constantly sharing their operation status and send and/or receive commands in implementations like industrial plants or production lines. Much focus has been dedicated into advancing the interconnectivity of such components by providing communication units for each of these components capable of connecting to networks such as local or remote wireless networks. However, these solutions are usually costly and require a complete redesign of the entities to be able to operate in an interconnected manner which enables efficient and meaningful generation and sharing of data for further analyses steps. Even further, all of the hardware components, operation drivers and proprietary software should be configured to operate in unison and be adapted to certain standards. This is to ensure that all stakeholders including the hardware producers, software developers, system maintenance solutions, third party applications, etc. would be able to access and operate the interconnected entities and utilize the generated data for system operation, maintenance and improvement as well as decision-making management. This whole range of requirements places an inflexible and challenging burden on all aspects of design and implementation of such interconnected automation systems, particularly when taking into account the magnitude of components such as sensor devices required to be installed and operate in industrial production plants.

Therefore, there is a need for solutions in the art which are capable of providing customized, efficient, secure and cost-efficient automation systems in line with the needs of each specific implementation for the target industrial plants.

US2021227630A1 describe a gateway 102 in an industrial process sensor network 100. The gateway 102 converts a wirelessly received sensor data signal received from the sensor 106 that the sensor 106 has created from an original sensor signal in order to be able to transmit it wirelessly to the gateway 102. The gateway 102 then process the wirelessly received sensor data signal.

### SUMMARY

It is therefore an object of the present disclosure to provide an adapter, a wireless communication access point in communication with at least one adapter, a mesh network comprising at least two adapters and at least one wireless communication access point, a system and a method, a computer-readable storage medium and a computer program product, which alleviate all or at least some of the drawbacks of presently known solutions.

More specifically, it is an object of the present disclosure to alleviate problems related to signal distribution in automation systems.

These objects are achieved by means of an adapter, a wireless communication access point in communication with at least one adapter, a mesh network comprising at least two adapters and at least one wireless communication access point, a system and a method as defined in the appended claims. The term exemplary is in the present context to be understood as serving as an instance, example or illustration.

According to a first aspect, there is provided an adapter for wireless distribution of sensor and/or control signals to an external network is disclosed. The adapter is arranged to be mounted in a transmission path of a sensor device and/or a control system and is configured to obtain at least one first sensor signal from the sensor device and/or at least one first control signal from the control system via connection terminals mounted in the transmission path of the sensor device and/or a control system. Further, the adapter is configured to convert each of the obtained at least one first signals to a corresponding at least one second signal such that each of the obtained at least one first signal is galvanically isolated from its corresponding second signal. The adapter is further configured to transmit wireless signals corresponding to each of the converted corresponding second signals to the external network wirelessly via at least one wireless communication access point located remotely from the adapter.

In some embodiments, the at least one first signal may be an electric signal, the at least one converted corresponding second signal may be an optical signal, and wherein the adapter may be further configured to convert each of the optical signals into wireless signals to be transmitted to the external network via the at least one wireless communication access point being in communication with the external network.

In several embodiments, the adapter may further comprise one or more optical converter units configured to provide the galvanic isolation between each of the first signals and its corresponding second signal upon converting the at least one first signals to their corresponding second signals. In some embodiments the optical converter may comprise a light emitting diode operating in infra-red spectrum.

In some embodiments the adapter may be further configured to be wirelessly connectable to at least one other adapter comprised in a mesh network, the mesh network comprising at least two adapters and at least one wireless communication access point. The adapter may thus be further configured to wirelessly transmit the second signal to at least one other adapter comprised in the mesh network such that the second signal may be transmitted to the external network via the at least one other adapter being in wireless communication with the at least one access point and the external network.

According to a second aspect, there is provided a wireless communication access point, configured to obtain a wireless signal from at least one adapter, according to the first aspect, for obtaining at least one sensor signal from one or more sensor devices and/or at least one control signal from a control system and further configured to transmit the obtained wireless signal to an external network.

According to a third aspect, there is provided a mesh network comprising at least two adapters, according to the first aspect, for obtaining at least one sensor signal from one or more sensor devices and/or at least one first control signal from one or more control system(s); and at least one wireless communication access point according to the second aspect being in wireless communication with the at least two adapters and in network communication with an external network. The mesh network is configured to distribute a plurality of sensor and/or control signals obtained from the at least two adapters to the external network via the at least one wireless communication access point.

In some embodiments, the at least one wireless communication access point may further be configured to be in communication with an external control system arranged to at least control an operation of the one or more sensor devices and/or one or more industrial machinery.

In some embodiments the at least one wireless communication access point may comprise a first access point and a second access point, the first access point being in wireless communication with the external network and the second access point being in communication with the first access point. Each of the first and the second access points may be in wireless communication with at least one adapter, such that the plurality of sensor- and/or control signals obtained from the at least two adapters in the mesh network may be transmitted to the external network via the first access point.

In several embodiments the first and the second access points may be configured such that, when the first access point being in wireless communication with the external network becomes unavailable to transmit the plurality of sensor- and/or control signals obtained from the at least two adapters to the external network, the second access point may be configured to establish a wireless communication with the external network and replace the first access point such that the sensor- and/or control signals may be transmitted to the external network via the second access point.

According to a fourth aspect, there is provided a system comprising at least one adapter according to any one of the embodiments of the first aspect, at least one wireless communication access point according to the second aspect and an external network configured to receive at least one wireless signal from the at least one adapter via the at least one wireless communication access point.

According to a fifth aspect, there is provided a computer-implemented method for monitoring operation of one or more sensor and/or control devices. The method comprises obtaining, from an external network, by means of a network interface, at least one wirelessly distributed sensor and/or control signal originating from, and distributed to the external network by each of one or more adapters according to any one of the embodiments of the first aspect. The method further comprises associating the at least one wirelessly distributed signal originating from each of the one or more adapters to the one or more sensor and/or control devices, each sensor and/or control device having a unique identifier. The method further comprises transferring via the network interface, signals associated to each sensor and/or control device having the unique identifier to a third party application on an external server and/or a user device in communication with the network interface and configured for monitoring and/or controlling an operation of the one or more sensor and/or control devices.

In some embodiments the method may further comprise creating, in the third party application, a representation of each sensor and/or control device based on the transferred signals associated to each sensor and/or control device having its corresponding unique identifier.

In some embodiments, the method may further comprise obtaining, in the third party application, at least one sensor-specific and/or control device-specific information for each sensor and/or control device based on the transferred signals associated to each sensor and/or control device having its corresponding unique identifier.

Thus, the present inventors have devised a flexible and versatile solution for data acquisition and processing associated with sensor and/or control devices in an automation system for industrial plants which could circumvent at least some of the above-mentioned problems. The present inventors have realized that by introducing the adapters according to the present disclosure into the configuration of industrial plants such as production lines, or during the designing process of such industrial plants for that matter, all the necessary signals and information from the sensor and/or control devices and the operating components such as industrial machinery, engines, motors, valves, etc. can be readily obtained and extracted. The proposed systems and methods thus provide flexibility and increased data security in design and implementation of automation systems while being cost-efficient. The obtained signals can then be transmitted to an external network for being stored and further processed, providing insight into the operation of the automation system and the industrial plant and thus enabling procedures such as plant maintenance and/or decision-making for further solution implementations and industrial plant operational schemes.

According to a sixth aspect of the present disclosure, there is provided a computer-readable storage medium storing one or more programs configured to be executed by one or more processors of a processing system, the one or more programs comprising instructions for performing the method according to any one of the embodiments of the method of the present disclosure.

According to a seventh aspect of the present invention, there is provided a computer program product comprising instructions which, when the program is executed by one or more processors of a processing system, causes the processing system to carry out the method according to any one of the embodiments of the method disclosed herein.

Embodiments of the different aspects are defined in the dependent claims.

It is to be noted that all the embodiments, elements, features and advantages associated with the first aspect also analogously apply to the second, third, fourth, fifth, sixth and the seventh aspects of the present disclosure.

These and other features and advantages of the present disclosure will in the following be further clarified in the following detailed description.

### BRIEF DESCRIPTION OF THE DRAWINGS

Further objects, features and advantages of embodiments of the disclosure will appear from the following detailed description, reference being made to the accompanying drawings. The drawings are not to scale.

FIG. 1a is a schematic block diagram illustrating an automation system according to embodiments of the present disclosure;

FIG. 1b is a schematic illustration of an adapter in accordance with several embodiments of the present disclosure;

FIG. 2 is a schematic illustration of a mesh network in accordance with several embodiments of the present disclosure;

FIG. 3 is a schematic illustration of a mesh network in accordance with an embodiment of the present disclosure; and

FIG. 4 is a schematic flowchart illustrating a method in accordance with several embodiments of the present disclosure.

### DETAILED DESCRIPTION

Those skilled in the art will appreciate that the steps, services and functions explained herein may be implemented using individual hardware circuitry, using software functioning in conjunction with a programmed microprocessor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the following description of exemplary embodiments, the same reference numerals denote the same or similar components.

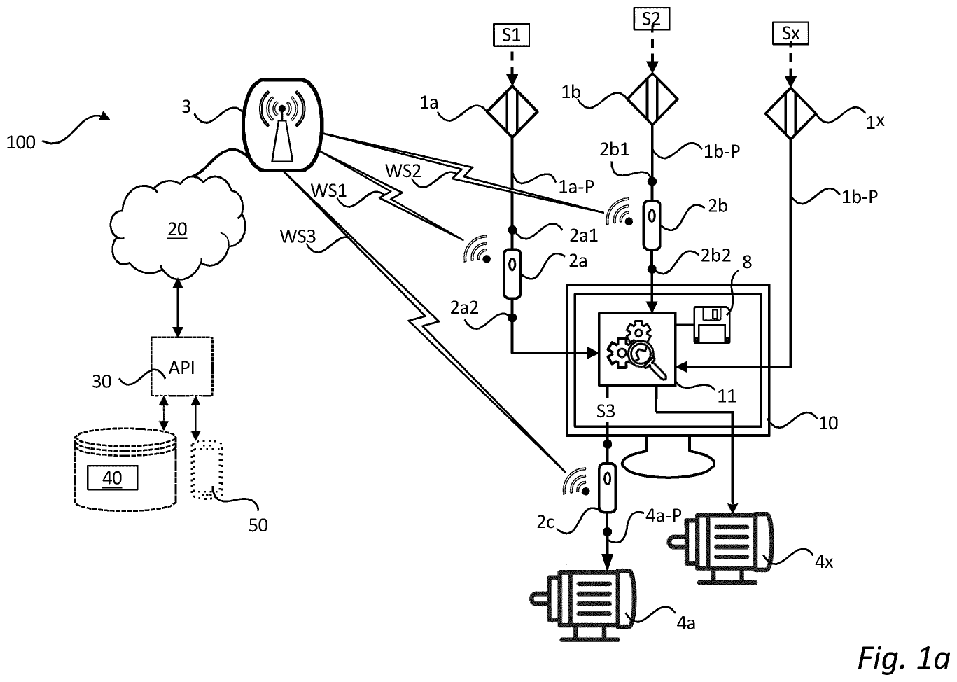

Conventionally, an industrial plant comprises a plurality of industrial machinery, with a large number of sensor devices, and control systems/devices installed, the output of which is obtained to gather information about the operation of the entire plant and each machinery. This is for example shown in FIG. 1a for sensor device 1x with a sensor readout signal Sx which is coupled to a control device 10 responsible for operation of an exemplary production line by controlling the operation of an exemplary motor device 4x based on the sensor readout signal Sx. In this scenario, a processing circuitry 11 of the control device 10 in conjunction with a memory unit 8 for storage and retrieving of device operation information and control commands, controls the operation of the production line. However, for digitization of the entire automation process, including sensor information acquisition and processing in the control system 10, it is oftentimes necessary to perform a full integration of the interconnecting network by adapting all the hardware and software components of the system such as the sensor devices 1x, the control systems 10 and the operation entities and machinery like the motor devices 4x etc.

Needless to say, such an integration process may amount to a substantial level of technical and financial investments which could expand exponentially by increasing and addition of more units of machinery and sensor devices in the industrial plant. This warrants for an intertwined cooperation amongst several entities and stakeholders such as the automation engineers, hardware and/or software suppliers, IT infrastructure providers, legal and licensing, and the like to install, establish and operate an interconnected network of machinery in an industrial plant. Thus, the present inventors have devised a flexible and versatile solution for data acquisition and processing associated with sensor and/or control devices in an automation system for industrial plants which could circumvent at least some of the above-mentioned problems.

FIG. 1a illustrates a schematic view of an automation system 100 according to several embodiments and aspects of the present disclosure. The system 100 comprises at least one adapter 2, including example adapters 2a, 2b in FIG. 1a, for wireless distribution of sensor signals S1, S2 to an external network 20. In various embodiments and aspect, the external network 20 may be a could network 20.

The at least one adapter 2 may also be referred to as a transceiver device 2 configured for receiving and/or transmitting wired and wireless signals. The sensor signals S1 and S2 are the output readout signals of the sensor devices 1a and 1b. The sensor devices 1a, 1b could be any suitable types of sensor devices based on the intended application such as temperature sensors, pressure sensors, proximity sensors, optical sensors like visible, UV, infrared cameras, or the like.

The system 100 further comprises at least one adapter 2, including example adapter 2c in FIG. 1a, for wireless distribution of control signals S3 to the external network 20. The control signals in the present context may be construed as the signals transmitted from a control system, also referred to as a control device, such as control device 10 in FIG. 1a to an entity or component 4a of the automation system 100.

Each adapter 2 is configured for obtaining at least one sensor signal S1, S2 from one or more sensor devices 1a, 1b. in this example adapter 2a obtains one sensor signal S1 from the sensor 1a and adapter 2b obtains one sensor signal S2 from the sensor 1b. However, in some embodiments, each adapter 2 may be configured to obtain multiple signals from a single sensing i.e. perception system and/or multiple signals from multiple sensing systems. The system 100 further comprises at least one wireless communication access point 3 configured to obtain a wireless signal WS1, WS2, WS3 from the at least one adapter 2. Thus each adapter 2 may be configured to receive at least one sensor signal and wirelessly transmit the obtained sensor signal to at least one wireless communication access point 3. The wireless communication access point 3 may also be referred to as a wireless hub or simply a hub in the rest of this specification. Each hub 3 in turn is configured to transmit the obtained wireless signals from the at least one adapter 2 to an external network 20. The hub 3 may be configured to transmit the obtained adapter signals WS1, WS2, WS3 to the external network 20 by means of a wired Ethernet local area network (LAN) configuration and/or by means of a wireless LAN configuration. The system 100 further comprises an external network 20 configured to receive the at least one wireless signal WS1, WS2, WS3 from the at least one adapter 2 via the at least one wireless communication access point 3.

The obtained signals can then be wirelessly transmitted to an access node 3 which in turn transmits the obtained signals WS1, WS2, WS3 to the external network 20.

The present inventors have realized that by introducing the wireless transceiver device 2 according to the present disclosure into the configuration of existing industrial plants such as production lines, or during the designing process of such industrial plants for that matter, all the necessary signals and information from the sensor and/or control devices and the operating components such as engines, motors, valves, etc. can be readily obtained and extracted. The obtained signals can then be transmitted to an external network 20 for being further processed, providing insight into the operation of the automation system and the industrial plant and thus enabling procedures such as plant maintenance and/or decision-making for further solution implementations and industrial plant operational schemes.

This outstanding advantage is achieved without the need to design and implement each and every component based on stringent operational standards, designated software and/or hardware equipment and their associated licensing criteria, and so on for providing implementation of the industrial plant automation solutions. In addition, the sensor and/or control signal acquisition and distribution is enabled without affecting the fidelity of the original signals such as the signals outbound from the sensor devices towards the control system 10 and/or from the control system 10 towards the machinery 4a of the production lines. Moreover, the operation systems of the installed machinery remain unaffected, since the adapters merely take snap readout of the information concerning the operation of the machinery without the need to directly connect to and interfere with the operation systems. A further advantage of the proposed solution in isolating the snap readouts from the original signals is the increased network and security. More specifically, by isolating the signal acquisition from the operation of the sensors, the control system and/or the machinery and their respective original signal transmissions in the production lines, no direct access to these entities is required by or provided to the third parties. By isolating the signal acquisition from the control system, the systems and methods according to the present disclosure thus drastically minimize the risks of malicious security interventions, such as hacking attempts on the data network and/or the control system, designed to jeopardize the operation of the industrial plants and/or the production lines.

The presented solution also provides the advantage of incorporating the existing and old generation equipment, which oftentimes are not compatible with the latest communication and automation system standards and protocols, into the plant automation solutions. This further contributes to providing cost-effective and flexible automation system solutions.

In the example of FIG. 1a, the sensor devices 1a and 1b having the readout output sensor signals S1 and S2 respectively are coupled to the control system 10 which in this case may be a programmable logic controller (PLC) having at least one processing circuitry 11 and at least a memory unit 8. The adapters 2a and 2b are arranged to be mounted in the transmission path 1a-P and 1b-P of the sensor devices 1a and 1b respectively. Each adapter 2a, 2b is configured to obtain at least one first sensor signal from its respective sensor device 1a, 1b and convert each of the obtained at least one first signals to a corresponding at least one second signal such that each of the obtained at least one first signal is galvanically isolated from its corresponding second signal. Further, each adapter device is also configured to transmit, each of the converted corresponding second signals to the external network 20 wirelessly via the at least one wireless communication access point 3 located remotely from the adapter 2a, 2b. In some embodiments and aspects the obtained sensor and/or control signals may be stored in log files, in a tabular format, or any other suitable format in the external network 20 or in external servers in communication with the external network 20.

The at least one hub 3 may be connected to external network(s) 20 via for instance a wired Ethernet network and/or via a wireless link via various technologies such as cellular long range or short range such as Wireless Local Area (LAN), WiFi, etc. communication technologies.

The system 100 of FIG. 1a further comprises an adapter 2c which is installed similarly as the adapters 2a, 2b, but in the transmission path 4a-P of a control signal sent by the control system 10 to an operation motor device 4a of the exemplary production line. Similarly, the adapter device 2c is configured to obtain at least one first control signal from the control system 10 and convert each of the obtained at least one first control signals to a corresponding at least one second control signal such that each of the obtained at least one first signal is galvanically isolated from its corresponding second signal. Further, the adapter device 2c is configured to transmit, each of the converted corresponding second signals to the external network 20 wirelessly via the at least one wireless communication access point 3 located remotely from the adapter 2c. The adapter devices 2 may be installed in the path of the various entities of an interconnected system such as the sensors, control devices, PLCs, etc. via standard connectors known in the field such as M8 or M12 connectors.

As illustrated in FIG. 1b, the adapter 2 may have one or more set(s) of connection terminals and be configured to accept one or more signals from sensor or control devices. For example in the schematic of FIG. 1b, the adapter device 2a has two sets of connection terminals 2a1-S1/2a2-S1 mounted in the associated signal transmission path for obtaining signal 1, S1, and 2a1-S2/2a2-S2 mounted in the associated signal transmission path for obtaining signal 2, S2. In several embodiments however, the adapter may have only one set of connection terminals as for instance shown for the adapters 2a and 2b in FIG. 1a. In some embodiments, each adapter may have 3, 4, 5, 6 or any suitable number of connections terminals configured for obtaining any suitable number of signals depending on the design and configuration parameters of the automation system 100. It should also be clear to the person skilled in the art that each of the signals S1 and/or S2 may belong to a separate sensor and/or control device or be obtained from a single sensor and/or control device. In other words, each adapter device may be configured for obtaining and handling any suitable number of signals received from any suitable number of external sensor and/or control devices.

As mentioned earlier the adapter 2 is configured to obtain the sensor and/or control signals and convert each of the obtained signals to a corresponding signal which is to be transmitted wirelessly by means of the adapter 2. Furthermore, each one of the obtained signals is galvanically isolated from its corresponding second signal. In various embodiments and aspects the at least one first signal is an electric signal, and the at least one converted corresponding second signal is an optical signal. To this end, each adapter 2 may comprise one or more optical converter units, such as two optical converter units 2a-C1, and 2a-C2 in FIG. 1b, configured to provide the galvanic isolation between each of the obtained first signals and its corresponding converted second signal upon converting the at least one first signals to their corresponding second signals. The adapter 2 may be further configured to convert each of the second optical signals back into electrical signals to be transmitted to the external network 20 wirelessly via the at least one wireless communication access point 3 being in wireless and/or wired network communication with the external network 20. Alternatively or additionally, the second optical signals may be transmitted by the adapter without being converted back to an electrical signal e.g. by using all-optical integrated circuits. In several embodiments and examples each one of the one or more optical converters 2a-C1, 2a-C2 may comprise a light source such as a light emitting diode (LED) 2a-D. The LEDs may e.g. be operating in infra-red (IR) spectrum. Further, each optical converter may comprise a dielectric barrier 2a-K and an optical sensor 2a-T such as a photoresistor, a phototransistor or a photodiode for receiving the emitted light by the LED. The optical sensor may also convert the received optical signal to an electrical signal which is bound to be transmitted wirelessly to the one or more hubs 3. Further details on operation and configuration of optical converters may be found in relevant literature known in the art.

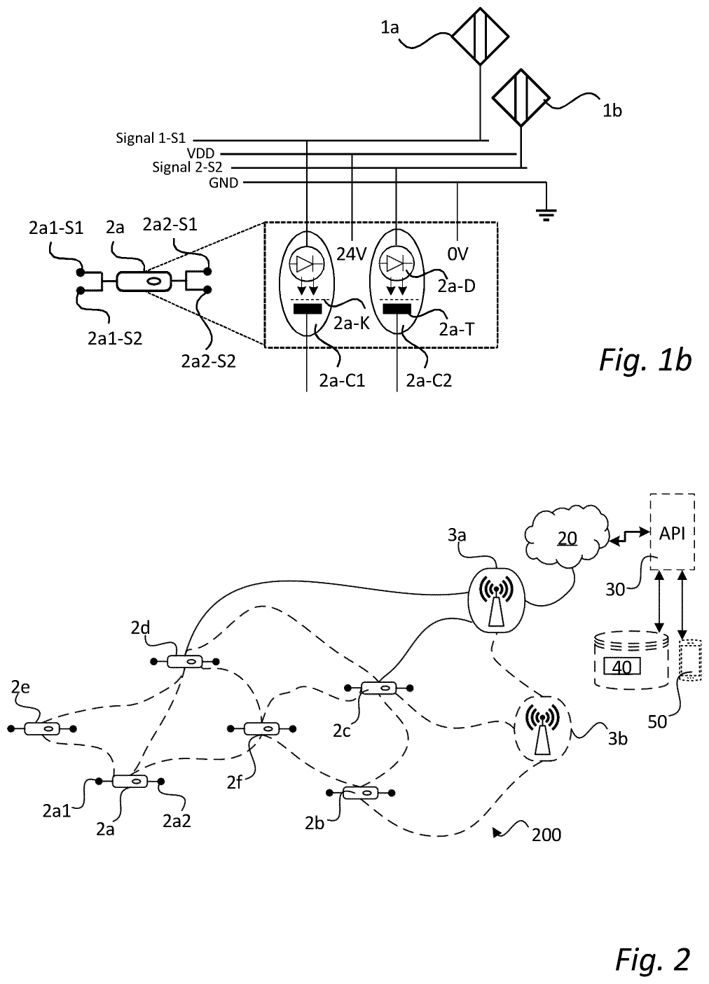

In several embodiments and aspects as shown in the example of FIG. 2 one or more of the adapter device(s) 2a-2f may be configured to be wirelessly connectable to at least one other adapter 2a-2f comprised in a mesh network 200, wherein the mesh network 200 may comprise at least two adapters and at least one wireless communication access point 3a, 3b.

The mesh network 200 in several embodiments and aspects may comprise at least two adapters 2a-2f configured for obtaining at least one first sensor signal from one or more sensor devices 1a, 1b and/or at least one first control signal from a control system 10. The mesh network 200 may further comprise at least one wireless communication access point 3a, 3b being in wireless communication with the at least two adapters 2a-2f and in wireless and/or wired network communication with the external network 20. The mesh network 200 may thus be configured to distribute a plurality of sensor and/or control signals obtained from the at least two adapters 2a-2f to the external network 20 via the at least one wireless communication access point 3. In the example of FIG. 2, the mesh network 200 comprises six adapter devices 2a-2f and two hubs 3a, 3b. However, it should be appreciated that the mesh network 200 may comprise any suitable number of adapters and hubs depending on the desired applications and operations.

The one or more adapter 2a-2f may be further configured to wirelessly transmit the second signal to at least one other adapter 2a-2f comprised in the mesh network 200 such that the second signal is transmitted to the external network 20 via the at least one other adapter 2a-2f being in wireless communication with the at least one access point 3a, 3b and the external network 20. Stated differently, each adapter may either via direct connection or indirectly via a secondary adapter relay it obtained sensor and/or control signals to the one or more hubs 3a, 3b. This way, each adapter device can transmit its obtained signals to a neighboring adapter device. The signals are forwarded until they reach the at least one hub 3a, 3b and subsequently the external network 20.

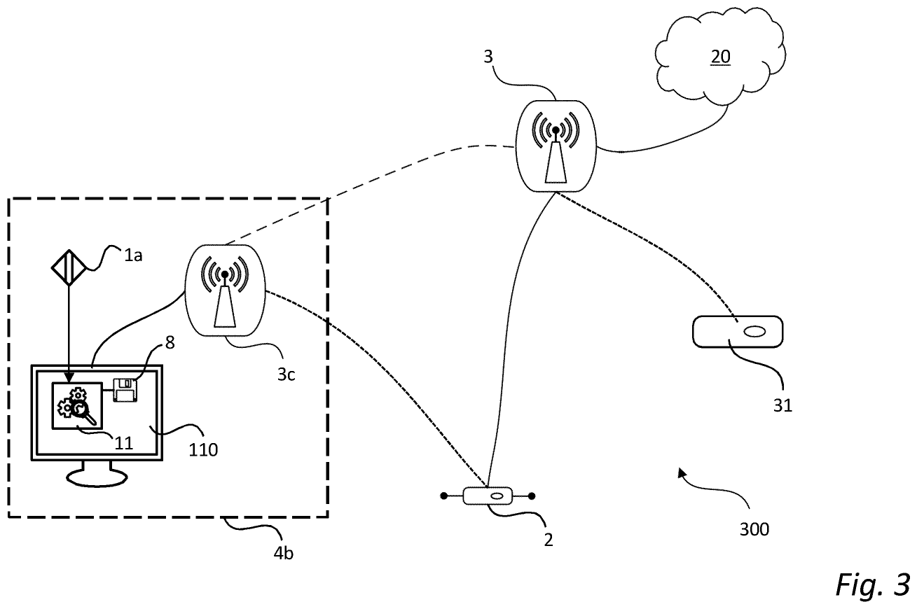

In several embodiments, the at least one wireless communication access point 3a, 3b may comprise a first access point 3a and a second access point 3b, the first access point 3a being in wireless and/or wired network communication with the external network 20 and the second access point 3b being in wireless and/or wired network communication with the first access point 3a. Each of the first and the second access points may be in wireless communication with at least one adapter 2a-2f, such that the plurality of sensor and/or control signals obtained from the at least two adapters 2a-2f in the mesh network 200 may be transmitted to the external network 20 via the first access point 3a. Stated differently, the mesh network may comprise any number of hubs, for example two hubs 3a, 3b in the example of FIG. 2 out of which one hub or access point is configured to operate as a master hub to be in direct wireless and/or wired network communication with the external network 20. For the example of FIG. 2, it is the hub 3a which is the master hub and is in direct communication with the external network 20, whereas the other hub 3b is configured to operate in the slave configuration and to relay all the signals obtained from its corresponding one or more adapter devices, the adapters 2c and 2b in this case, to the master access point 3a. The master hub 3a in turn may be configured to transmit the received signals from the slave hub 3b to the external network 20. As shown in FIG. 2, it should be clear to the person skilled in the art that one or more of the adapter devices 2a-2f might be in communication with more than one hub 3a, 3b. For instance, adapter 2c is in communication with both the master hub 3a and the slave hub 3b. Such communication might be a direct communication and/or be transmitted via one or more other adapters in the mesh network. The adapters 2a-2f and hubs 3a, 3b in the mesh network may implement any hand-shake protocols known in the art for acknowledgment of data transmission and reception. An adapter 2a-2f being in communication with several hubs 3a, 3b may thus chose to send its data to either one of those hubs 3a, 3b based on such hand-shake protocols or data-queuing protocols. In some embodiments, any one of the at least one hub 3a, 3b may be configured to operate as a gateway, thus directly forwarding the data obtained from the adapter devices 2a-af to the cloud network 20. When using this function, there might be no programming and/or signal processing operations applied to the obtained signals in the hubs. In several embodiments and aspects, the hubs 3a, 3b may comprise a PLC runtime based on standards such as IEC 61131-3. This turns each hub to operate as a wireless PLC unit to which one or more input/output (I/O) units 31 may be coupled wirelessly as shown in FIG. 3.

In some embodiments the first and the second access points 3a, 3b may be configured such that, when the first access point 3a being in communication with the external network 20 becomes unavailable to transmit the plurality of sensor and/or control signals obtained from the at least two adapters to the external network, the second access point 3b may establish a wireless and/or wired network communication with the external network. Thus, the second hub 3b replaces the first access point 3a as the master hub such that the sensor and/or control signals may be transmitted to the external network 20 via the second access point 3b. In some embodiments, when the first master hub 3a or any one of the other hubs incorporated in the mesh network becomes unavailable e.g. due to an error or malfunction, a fault reporting or fail signal may be generated and reported to the external network 20 or other control and processing entities in communication with the external network 20 for system maintenance purposes.

It is needless to emphasize that the same principle may analogously be applied to a mesh network 200 comprising 3, 4, 5 or any suitable number of access points configured to operate under a master-slave configuration. Similarly, if one or more of the adapter devices 2a-2f become unavailable, the remaining adapter devices may seek connection with other functional adapter devices and/or hubs to relay their signals to at least one of the hubs. Accordingly, a self-healing functionality is provided for the mesh network enabling the network to be continuously operational even in an event of network component failures, thus minimizing repair and maintenance requirements.

In some embodiments, the at least one wireless communication access point 3 may further configured to be in communication with an external control system 110 such as a PLC arranged to at least control an operation of the one or more sensor devices or machinery in an automation system. For instance, the control device 110 in FIG. 3 is implemented together with hub 3c. This way the control system 110 of the machinery 4b, which may be a previous generation machinery lacking any of the up to date hardware and/or software automation components directly integrated therein, can readily be incorporated into the automation system 300 for transmission of sensor and/or control signals. In some embodiments, the hub 3c may be configured to be connected to RS-485 or RS-232 standard ports via USB links for communication with the older generation serial bus systems in the PLC 110.

Sensor and/or control signals may be obtained online i.e. in real-time and/or e.g. from a memory 8 of the control system 10 storing historic data of the sensor and/or control signals in a log file, in tabular format or the like.

The memory 8 of the control system 10 can include one or more (non-transitory) computer-readable storage mediums, for storing computer-executable instructions, signal data and the like. The memory 8 optionally includes high-speed random access memory, such as DRAM, SRAM, DDR RAM, or other random access solid-state memory devices; and optionally includes non-volatile memory, such as one or more magnetic disk storage devices, optical disk storage devices, flash memory devices, or other non-volatile solid-state storage devices. The memory 8 may include database components, object code components, script components, or any other type of information structure for supporting the various activities of the present description. According to an exemplary embodiment, any distributed or local memory device may be utilized with the systems and methods of this description. According to an exemplary embodiment the memory 8 is communicably connected to the processor 11 of the control system (e.g., via a circuit or any other wired, wireless, or network connection).

Solutions according to this embodiment may provide an advantage of facilitating integration of a multitude of machinery into the automation system with minimal network design and implementation costs. Albeit solutions according to this embodiment may result in a tradeoff between the scalability and network security of the automation system, since at least some control nodes may be coupled to the signal acquisition network.

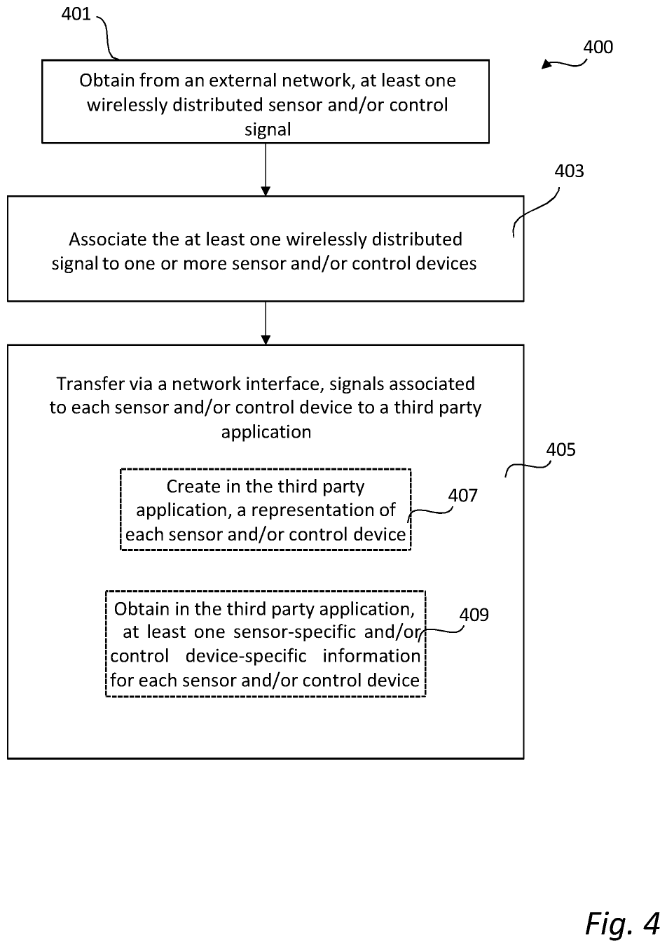

FIG. 4 shows a flowchart of a method according to several aspects and embodiments of the present disclosure. Accordingly a computer-implemented method 400 performed at least partly by a network interface 30 and/or by processing circuitry in an external server 40 and/or a user device 50 in communication with the network interface 30 for monitoring and/or controlling an operation of one or more sensor and/or control device(s) is presented. FIG. 1a and FIG. 2 show a network interface 30 which in several embodiments may be an application programing interface (API) 30.

The network interface e.g. the API 30, enables opening up the applications' data and functionality to external third-party developers, operation and control platforms, business partners, or any other internal departments. This allows services and products to communicate with each other and leverage each other's data and functionality through a documented interface. Developers don't need to know how an API is implemented; they simply use the network interface 30 to communicate with other products and services. Thus, the external servers 40 and third party software and platforms may advantageously and securely obtain the signal data of the sensor and/or control signals from the automation system 100, 200, 300 wirelessly distributed by the one or more adapters and consequently apply customized data analysis and/or processing on the obtained data.

The method 400 comprises obtaining 401, from an external network 20, by means of a network interface 30, at least one wirelessly distributed sensor and/or control signal originating from, and distributed to the external network by each of one or more adapters 2a-2f for wireless distribution of sensor and/or control signals to the external network 20. The method 400 further comprises associating 403 the at least one signal originating from each of the one or more adapters 2a-2f to the one or more sensor and/or control devices, each sensor and/or control device having a unique identifier. Further, the method 400 comprises transferring 405 via the network interface 30, signals associated to each sensor and/or control device having the unique identifier to a third party application on an external server 40 and/or a user device 50 in communication with the network interface 30 and configured for monitoring and/or controlling an operation of the one or more sensor and/or control devices.

In some embodiments, the method 400 may further comprise creating 407, in the third party application, a representation of each sensor and/or control device based on the transferred signals associated to each sensor and/or control device having its corresponding unique identifier.

In some embodiments, the method 400 may further comprise obtaining 409, in the third party application, at least one sensor-specific and/or control device-specific information for each sensor and/or control device based on the transferred signals associated to each sensor and/or control device having its corresponding unique identifier. As such, various parameters of the machinery component can be readily extracted from the obtained information based on the processed sensor and/or control signal data, providing a deep insight into the operation of each component.

The unique identifier in the present context may be construed as an identification tag assigned to each sensor and/or control device comprised in the automation system 100, 200, 300 onto which signal processing steps may be applied.

Accordingly in several exemplary embodiments a cloud computing system 20, 30, 40, 50 can be configured to perform data analysis and/or processing on the obtained sensor and/or control signals. The cloud computing system may comprise distributed cloud computing resources, processing circuitry, user interfaces, and the like that may jointly apply signal processing steps to the obtained signals for maintenance or decision-making purposes. Various parameters of the machinery component can be readily extracted from the processed sensor and/or control signal data, providing a deep insight into the operation of each component. This way faulty components or causes of errors and failures in the operation of the machinery can be identified and resolved. Advantageously, none of the components of such a could computing system 20, 30, 40, 50 need to be implemented in line with stringent software and/or hardware compliance with the sensor devices and/or control systems comprised in the automation systems 100, 200, 300. Thus, this configuration provides a considerable degree of flexibility in digitizing the automation systems and post processing of the obtained data from the industrial plants by means of third-party hardware and/or software products.

The present disclosure has been presented above with reference to specific embodiments. However, other embodiments than the above described are possible and within the scope of the disclosure. Different method steps than those described above, performing the method by hardware or software, may be provided within the scope of the disclosure.

As used herein, the term “if” may be construed to mean “when or “upon” or “in response to determining or “in response to detecting” depending on the context. Similarly, the phrase “if it is determined’ or “when it is determined” may be construed to mean “upon determining or “in response to determining” or “upon detecting and identifying occurrence of an event” or “in response to detecting occurrence of an event” depending on the context. The term “obtaining” is herein to be interpreted broadly and encompasses receiving, retrieving, collecting, acquiring, and so forth directly and/or indirectly between two entities configured to be in communication with each other or with other external entities.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the disclosure may be at least in part implemented by means of both hardware and software, and that several “means” or “units” may be represented by the same item of hardware.

Although the figures may show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. The above mentioned and described embodiments are only given as examples and should not be limiting to the present disclosure. Other solutions, uses, objectives, and functions within the scope of the disclosure as claimed in the below described patent embodiments should be apparent for the person skilled in the art.

1. An adapter for wireless distribution of sensor and/or control signals to an external network, wherein the adapter is arranged to be mounted in a transmission path of a sensor device and/or a control system and is configured to:
obtain at least one first sensor signal from the sensor device and/or at least one first control signal from the control system via connection terminals mounted in the transmission path of the sensor device and/or the control system;
convert each of the obtained at least one first signals to a corresponding at least one second signal such that each of the obtained at least one first signal is galvanically isolated from its corresponding second signal; and
transmit wireless signals corresponding to each of the converted corresponding second signals to the external network wirelessly via at least one wireless communication access point located remotely from the adapter.

2. The adapter according to claim 1, wherein the at least one first signal is an electric signal, the at least one converted corresponding second signal is an optical signal, and wherein the adapter is further configured to convert each of the optical signals into wireless signals to be transmitted to the external network via the at least one wireless communication access point being in communication with the external network.

3. The adapter according to claim 2, wherein the adapter further comprises one or more optical converter units configured to provide the galvanic isolation between each of the first signals and its corresponding second signal upon converting the at least one first signals to their corresponding second signals.

4. The adapter according to claim 3, wherein the optical converter comprises a light emitting diode operating in infra-red spectrum.

5. The adapter according to claim 1, wherein the adapter is configured to be wirelessly connectable to at least one other adapter comprised in a mesh network, the mesh network comprising at least two adapters and at least one wireless communication access point.

6. The adapter according to claim 5, wherein the adapter is further configured to wirelessly transmit the second signal to at least one other adapter comprised in the mesh network such that the second signal is transmitted to the external network via the at least one other adapter being in wireless communication with the at least one access point and the external network.

7. A wireless communication access point, configured to:
obtain a wireless signal from at least one adapter, according to claim 1, for obtaining at least one sensor signal from one or more sensor devices and/or at least one control signal from a control system; and
transmit the obtained wireless signal to an external network.

8. A mesh network comprising at least two adapters, each of which according to claim 1, for obtaining at least one sensor signal from one or more sensor devices and/or at least one first control signal from one or more control system(s); and
at least one wireless communication access point being in wireless communication with the at least two adapters and in network communication with an external network;
the mesh network configured to distribute a plurality of sensor and/or control signals obtained from the at least two adapters to the external network via the at least one wireless communication access point.

9. The mesh network according to claim 8, wherein the at least one wireless communication access point is further configured to be in communication with an external control system arranged to at least control an operation of the one or more sensor devices and/or one or more industrial machinery.

10. The mesh network according to claim 8, wherein the at least one wireless communication access point comprises a first access point and a second access point, the first access point being in communication with the external network and the second access point being in communication with the first access point, each of the first and the second access points being in wireless communication with at least one adapter, such that the plurality of sensor and/or control signals obtained from the at least two adapters in the mesh network is transmitted to the external network via the first access point.

11. The mesh network according to claim 10, wherein the first and the second access points are configured such that, when the first access point being in communication with the external network becomes unavailable to transmit the plurality of sensor- and/or control signals obtained from the at least two adapters to the external network, the second access point is configured to establish a communication with the external network and replaces the first access point such that the sensor and/or control signals are transmitted to the external network via the second access point.

12. A system comprising:
at least one adapter according to claim 1;
at least one wireless communication access point; and
an external network configured to receive at least one wireless signal from the at least one adapter via the at least one wireless communication access point.

13. A computer-implemented method for monitoring operation of one or more sensor and/or control devices, the method comprising:
obtaining, from an external network, by means of a network interface, at least one wirelessly distributed sensor and/or control signal originating from, and distributed to the external network by each of one or more adapters according to claim 1;
associating the at least one wirelessly distributed signal originating from each of the one or more adapters to the one or more sensor and/or control devices, each sensor and/or control device having a unique identifier; and
transferring via the network interface, signals associated to each sensor and/or control device having the unique identifier to a third party application on an external server and/or a user device in communication with the network interface and configured for monitoring and/or controlling an operation of the one or more sensor and/or control devices.

14. The method according to claim 13, wherein the method further comprises: creating, in the third party application, a representation of each sensor and/or control device based on the transferred signals associated to each sensor and/or control device having its corresponding unique identifier.

15. The method according to claim 13, wherein the method further comprises:
obtaining, in the third party application, at least one sensor-specific and/or control device-specific information for each sensor and/or control device based on the transferred signals associated to each sensor and/or control device having its corresponding unique identifier.
